(19) United States
(12) Patent Application Publication
(10) Pub. No.: US 2025/0172892 A1
(43) Pub. Date: May 29, 2025

(54) IMAGE FORMING APPARATUS

(71) Applicant: BROTHER KOGYO KABUSHIKI KAISHA, Nagoya (JP)

(72) Inventors: Shota SHINOYA, Nisshin (JP); Tomoyuki MIZUNO, Nagoya (JP)

(73) Assignee: BROTHER KOGYO KABUSHIKI KAISHA, Nagoya (JP)

(21) Appl. No.: 19/039,361

(22) Filed: Jan. 28, 2025

Related U.S. Application Data
(63) Continuation of application No. PCT/JP2023/026199, filed on Jul. 18, 2023.

(30) Foreign Application Priority Data
Jul. 29, 2022 (JP) 2022-121595
Jul. 11, 2023 (JP) 2023-113542

(51) Int. Cl. G03G 15/20; B65H 35/00; G03G 15/00

(52) U.S. Cl. CPC G03G 15/2028; B65H 35/008; B65H 35/0093; G03G 15/6582; G03G 2215/00814; G03G 2215/2025

(57) ABSTRACT

An image forming apparatus includes: an apparatus main body; an image forming unit configured to form an image on a sheet; a fixing unit including a heating rotation body and a pressure rotation body that forms a nip portion between the heating rotation body and the pressure rotation body, and configured to fix the image onto the sheet; and a cutter disposed downstream of the fixing unit in a conveying direction of the sheet and capable of cutting the sheet. The cutter is capable of cutting the sheet at a center position of the sheet in the conveying direction. A distance by which the sheet is conveyed from the nip portion to the cutter is larger than half of a dimension of the sheet to be cut in the conveying direction.

### REFERENCE TO RELATED APPLICATIONS

This is a continuation application of International Application No. PCT/JP2023/026199 filed on Jul. 18, 2023, which claims priority from Japanese Patent Application No. 2022-121595 filed on Jul. 29, 2022 and Japanese Patent Application No. 2023-113542 filed on Jul. 11, 2023. The entire contents of the aforementioned applications are incorporated herein by reference.

### BACKGROUND ART

In the related art, an image forming apparatus including a cutter has been known. The image forming apparatus can cut one sheet into two portions when determining that the sheet needs to be cut.

### SUMMARY

However, in an image forming apparatus in which a toner image formed by image formation is heated and pressurized at a nip portion of a fixing unit and is fixed, there is a problem that a sheet is heated and pressurized more than necessary at the nip portion when the conveyance of the sheet is stopped in a state in which the entire sheet does not pass through the nip portion and the sheet is cut.

Therefore, an object of the present invention is to cut a sheet in a state in which the entire sheet has passed through a nip portion.

An image forming apparatus for achieving the above object includes an apparatus main body, an image forming unit, a fixing unit, and a cutter. The image forming unit forms an image on a sheet. The fixing unit includes a heating rotation body and a pressure rotation body that forms a nip portion between the heating rotation body and the pressure rotation body, and fixes the image onto the sheet. The cutter is disposed downstream of the fixing unit in a conveying direction of the sheet S and is capable of cutting the sheet S. The cutter can cut the sheet at a center position of the sheet in the conveying direction. A distance by which the sheet is conveyed from the nip portion to the cutter is larger than half of a dimension of the sheet to be cut in the conveying direction.

Further, a configuration may be adopted in which the cutter is capable of cutting the sheet having at least A4 size at the center position of the sheet in the conveying direction, and the distance by which the sheet is conveyed from the nip portion to the cutter in the conveying direction is larger than half of a dimension of the sheet having the A4 size in the conveying direction.

Further, a configuration may be adopted in which the cutter is capable of cutting the sheet having at least letter size at the center position of the sheet in the conveying direction, and the distance by which the sheet is conveyed from the nip portion to the cutter in the conveying direction is larger than half of a dimension of the sheet having the letter size in the conveying direction.

Further, a configuration may be adopted in which a conveying roller located upstream of the cutter in the conveying direction of the sheet and rotatable in an axial direction, and configured to convey the sheet toward the cutter; and a discharge roller located downstream of the cutter in the conveying direction of the sheet and rotatable in the axial direction, and configured to discharge the sheet to the outside of the apparatus main body, are further included, and dimensions of the conveying roller and the discharge roller in the axial direction are larger than half of a width of the sheet having a maximum width and capable of being conveyed by the image forming apparatus.

Further, a configuration may be adopted in which the dimension of at least one of the conveying roller and the discharge roller in the axial direction is larger than the width of the sheet having the maximum width and capable of being conveyed by the image forming apparatus.

Further, a configuration may be adopted in which a conveying roller located upstream of the cutter in the conveying direction of the sheet and configured to convey the sheet toward the cutter; a re-conveying path configured to guide the sheet that has passed through the fixing unit toward the image forming unit again; and a controller are further included, the controller causes the cutter to cut one sheet into two sheets, and the controller causes the conveying roller to rotate in a reverse direction to allow a sheet on an upstream side in the conveying direction of the cut sheets to be conveyed toward the re-conveying path.

Further, a configuration may be adopted in which a controller is further included, and when receiving a command to cut the sheet, the controller cuts the sheet in a state in which the conveyance of the sheet stops.

Further, a configuration may be adopted in which a first conveying path configured to guide the sheet fixed by the fixing unit to the outside of the apparatus main body; a second conveying path different from the first conveying path and configured to guide the sheet fixed by the fixing unit to the outside of the apparatus main body; and a controller are further included, when the sheet is not cut by the cutter, the controller conveys the sheet to the first conveying path, and when the sheet is cut by the cutter, the controller conveys the sheet to the second conveying path.

Further, a configuration may be adopted in which a first discharge port through which the sheet is discharged from the first conveying path to the outside of the apparatus main body; and a second discharge port through which the sheet is discharged from the second conveying path to the outside of the apparatus main body, are further included, the first discharge port is located closer to the fixing unit than the second discharge port.

Further, a configuration may be adopted in which a controller is further included, when receiving a command to cut the sheet, the controller causes the cutter to cut the sheet in a case in which a dimension in the conveying direction from an expected cutting point of the sheet to a trailing end position of the sheet is smaller than a conveying distance of the sheet from the nip portion to the cutter.

Further, a configuration may be adopted in which an input unit capable of inputting a cutting point of the sheet is further included, and the controller cuts the sheet based on a command input to the input unit.

Further, a configuration may be adopted in which a conveying roller located upstream of the cutter in the conveying direction of the sheet and configured to convey the sheet to the cutter; and a controller are further included, and when the sheet is conveyed to the cutter, the controller starts to rotate the conveying roller after a leading end of the sheet in the conveying direction comes into contact with the conveying roller.

Further, a configuration may be adopted in which a conveying roller located upstream of the cutter in the conveying direction of the sheet and configured to convey the sheet toward the cutter; and a discharge roller located downstream of the cutter in the conveying direction of the sheet and configured to discharge the sheet to the outside of the apparatus main body, are further included, and a conveying speed by the discharge roller is higher than a conveying speed by the conveying roller.

### BRIEF DESCRIPTION OF THE DRAWINGS

FIG. 1 is a diagram showing a configuration of an image forming apparatus.

FIG. 2 is a perspective view of a cutter.

FIG. 3 is a partially enlarged view of FIG. 2.

FIG. 4 is a diagram showing a conveying distance from a nip portion to the cutter.

FIG. 5 is a diagram for comparing dimensions of a sheet, a switchback roller, and a second discharge roller in an axial direction.

FIG. 6 is a diagram showing electrical connection among a controller, respective motors, a flapper, and respective sensors.

FIG. 7 is a flowchart showing an example of a process executed by the controller after a job is received.

FIG. 8 is a time chart for explaining timings of sheet feeding, sheet conveyance, and cutting controlled by the controller.

FIG. 9 is a diagram showing the image forming apparatus in which the cut sheet is discharged.

FIG. 10 is a diagram showing the image forming apparatus including a second discharge tray.

FIG. 11 is a diagram showing the image forming apparatus including a scanner unit.

FIG. 12A shows the sheet cut into two portions by the cutter, and FIG. 12B shows the discharged sheet and the sheet guided to a re-conveying path.

FIGS. 13A to 13C are diagrams for explaining a movement of the sheet in a trailing end avoiding control, FIG. 13A shows a state in which a trailing end of the sheet is located at the nip portion, FIG. 13B shows a state in which an expected cutting point of the sheet is located downstream of the cutter, and FIG. 13C shows a state in which the trailing end of the sheet enters the re-conveying path.

FIG. 14 is a flowchart showing an example of a process executed by the controller.

FIG. 15 is a time chart for explaining timings of sheet feeding, sheet conveyance, and cutting.

### DESCRIPTION

Next, an embodiment of the present disclosure will be described in detail with reference to the drawings as appropriate.

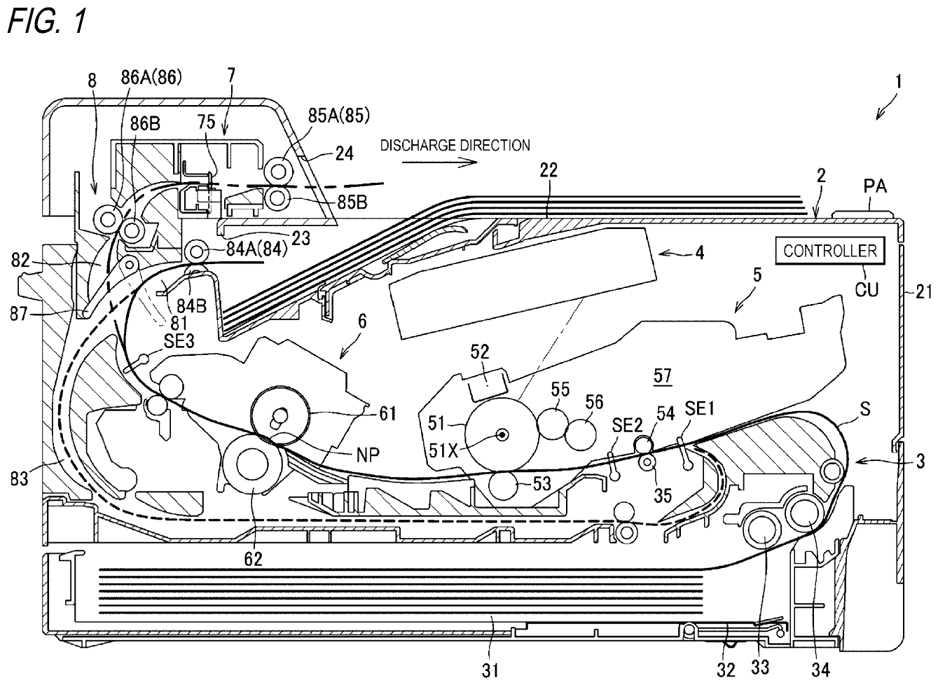

In the following description, an axial direction of a photosensitive drum 51 is referred to as an “axial direction”. A discharge direction of a sheet S discharged by a first discharge roller 84 (a direction indicated by the arrow in FIG. 1) is referred to as a “discharge direction”.

As shown in FIG. 1, an image forming apparatus 1 refers to a laser printer.

The image forming apparatus 1 includes an apparatus main body 2, a feed unit 3, an exposure device 4, a drum cartridge 5, a fixing unit 6, a cutter 7, a sheet conveying unit 8, an operation panel PA as an example of an input unit, a sensor SE, and a controller CU. The exposure device 4 and the drum cartridge 5 are examples of an image forming unit, and form an image on the sheet S.

The apparatus main body 2 includes a front cover 21, a discharge tray 22, a first discharge port 23, and a second discharge port 24. The front cover 21 is located downstream in the discharge direction in the apparatus main body 2. The discharge tray 22 is formed on an upper surface of the apparatus main body 2. The discharge tray 22 is a tray on which discharged sheets are placed.

The first discharge port 23 is a discharge port for discharging the sheet S to the outside of the apparatus main body 2. The first discharge port 23 is located below the second discharge port 24. In other words, the first discharge port 23 is located closer to the fixing unit 6 to be described later than the second discharge port 24. In the present embodiment, the first discharge port 23 discharges the sheet S, which is not cut by the cutter 7, to the outside of the apparatus main body 2.

The sheet S discharged from the first discharge port 23 is placed on the discharge tray 22.

The second discharge port 24 is a discharge port different from the first discharge port 23 for discharging the sheet S to the outside of the apparatus main body 2. The second discharge port 24 is located above and downstream of the first discharge port 23 in the discharge direction. In the present embodiment, the second discharge port 24 mainly discharges the sheet S, which is cut by the cutter 7, to the outside of the apparatus main body 2. The sheet S discharged from the second discharge port 24 is placed on the discharge tray 22.

The feed unit 3 is located inside the apparatus main body 2. The feed unit 3 includes a feed tray 31, a sheet pressing plate 32, a pickup roller 33, a separation roller 34, and a registration roller 35.

The feed tray 31 is a tray on which the sheet S is placed. The sheet pressing plate 32 pushes upward the sheet S in the feed tray 31. The pickup roller 33 picks up the sheet S in the feed tray 31. The separation roller 34 separates the sheet S picked up by the pickup roller 33 one by one. The registration roller 35 conveys the sheet S between the photosensitive drum 51 and a transfer roller 53.

The exposure device 4 is located at an upper portion inside the apparatus main body 2. The exposure device 4 includes a laser emitter, a polygon mirror, a lens, a reflective mirror, and the like, which are not shown. In the exposure device 4, a laser beam (see a chain line) based on image data emitted from the laser emitter is scanned at a high speed on a surface of the photosensitive drum 51 to expose the surface of the photosensitive drum 51.

The drum cartridge 5 is attachable to and detachable from the apparatus main body 2. When the drum cartridge 5 is attached to the apparatus main body 2, the drum cartridge 5 is located below the exposure device 4. The drum cartridge 5 is attached and detached in a state in which the front cover 21 is opened.

The drum cartridge 5 includes the photosensitive drum 51, a charger 52, the transfer roller 53, a pinch roller 54, a developing roller 55, a feed roller 56, and a toner containing portion 57.

The photosensitive drum 51 is rotatable about a drum shaft 51X extending in a first direction. The charger 52 charges the surface of the photosensitive drum 51. The transfer roller 53 is located to face the photosensitive drum 51. The transfer roller 53 transfers a toner image formed on the photosensitive drum 51 to the sheet S. The charger 52 is a scorotron charger. The pinch roller 54 is located to face the registration roller 35. The pinch roller 54 rotates following the rotation of the registration roller 35 to convey the sheet S together with the registration roller 35.

The developing roller 55 feeds the toner to the photosensitive drum 51 in a state of being in contact with the photosensitive drum 51. The feed roller 56 feeds the toner in the toner containing portion 57 to the developing roller 55.

In the drum cartridge 5, the surface of the photosensitive drum 51 is uniformly charged by the charger 52. Thereafter, the surface of the photosensitive drum 51 is exposed by the high-speed scanning of the laser beam from the exposure device 4, so that an electrostatic latent image based on the image data is formed on the photosensitive drum 51.

The toner carried on the developing roller 55 is fed from the developing roller 55 to the electrostatic latent image formed on the photosensitive drum 51. As a result, the electrostatic latent image is visualized, and the toner image is formed on the photosensitive drum 51. Thereafter, the sheet S is conveyed between the photosensitive drum 51 and the transfer roller 53, so that the toner image on the photosensitive drum 51 is transferred onto the sheet S.

The fixing unit 6 is located behind the drum cartridge 5. The fixing unit 6 includes a heating unit 61 as an example of a heating rotation body and a pressure roller 62 as an example of a pressure rotation body. The heating unit 61 includes a halogen heater, a fixing belt, a nip plate, and the like without reference symbols. The pressure roller 62 sandwiches the fixing belt between the pressure roller 62 and the nip plate of the heating unit 61. The pressure roller 62 forms a nip portion NP between the pressure roller 62 and the heating unit 61. In the fixing unit 6, the toner image transferred onto the sheet S is thermally fixed onto the sheet S when the sheet S passes between the heating unit 61 and the pressure roller 62.

The cutter 7 is capable of cutting the sheet S and is located at an upper portion of the apparatus main body 2. In the present embodiment, the cutter 7 is disposed in a second conveying path 82 to be described later.

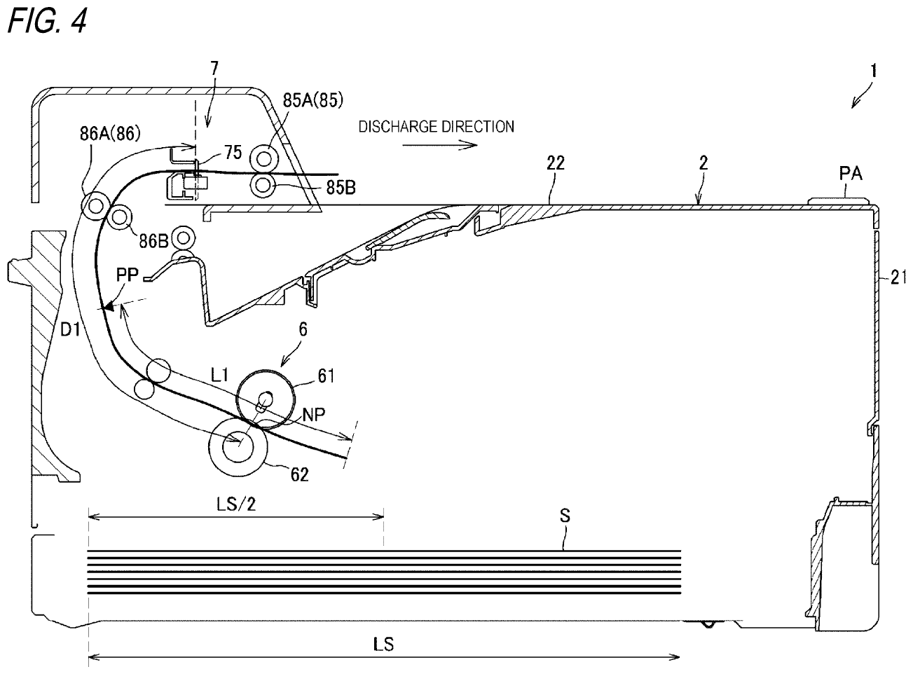

The image forming apparatus according to the present embodiment can only cut, by the cutter 7, a sheet having letter size as a specific size among sheet sizes by which image formation can be performed. For example, the image formation can be performed on sheets having A4 size, the letter size, legal size, B5 size, A5 size, A6 size, and postcard size, and only the sheet having the letter size as the specific size among these sheets can be cut after the image formation. As shown in FIG. 4, the cutter 7 is capable of cutting the sheet S having the letter size at a center position of the sheet in a conveying direction. The sheet S cannot be conveyed after cutting at least when the length of the sheet S subjected to the image formation is smaller than a distance between a second discharge roller 85 to be described later and a switchback roller 86 in the conveying direction. Among the above sheets, for example, the sheets having the A4 size, the letter size, and the legal size can be conveyed after the cutting because dimensions thereof in the conveying direction are larger than the distance between the second discharge roller 85 and the switchback roller 86 in the conveying direction.

Further, in the image forming apparatus according to the present embodiment, the sheet S having the letter size, whose sheet size in the conveying direction is smallest, is designed to be cuttable. In other words, it is necessary that a trailing end of the sheet S having the letter size has passed through the nip portion NP in a state in which a center portion of the sheet in the conveying direction is conveyed to the position of the cutter 7. Therefore, a conveying distance D1 by which the sheet S is conveyed from the nip portion NP to the cutter 7 is designed to be larger than half of a dimension LS of the sheet S having the letter size in the conveying direction. (D1>LS/2). Since the sheet S having the letter size is 215.9 mm×279.4 mm, the half of the dimension LS of the sheet having the letter size in the conveying direction is 139.7 mm. Therefore, the D1 is set to a value larger than 139.7 mm. In the image forming apparatus according to the present embodiment, the sheet is conveyed such that long sides thereof are along the conveying direction, and is subjected to the image formation.

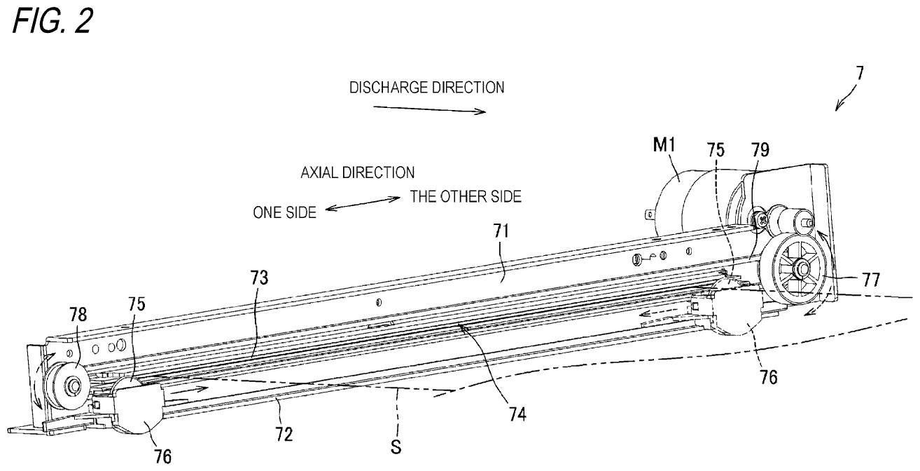

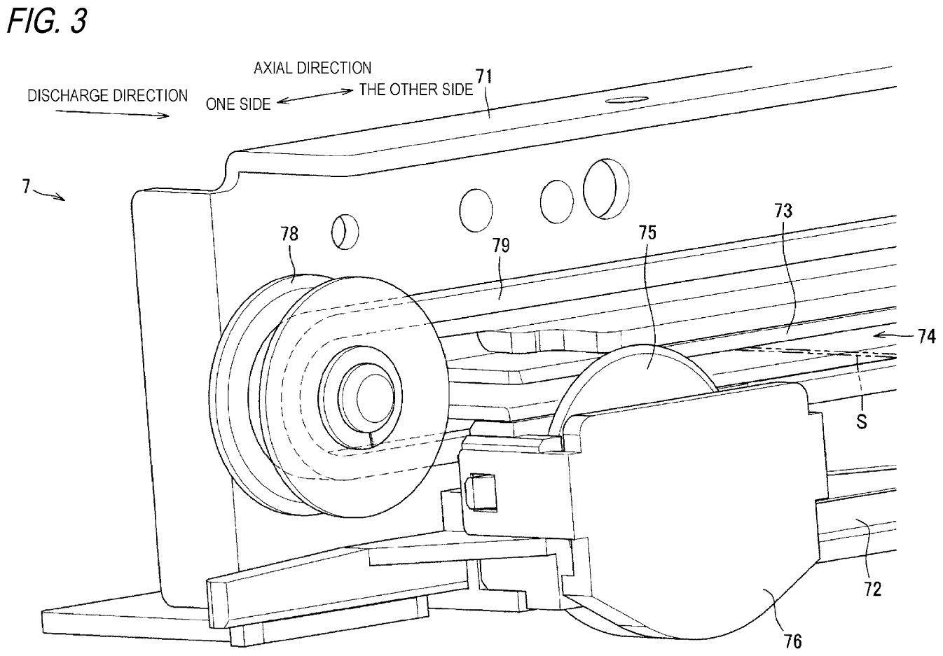

As shown in FIGS. 2 and 3, the cutter 7 includes a cutter frame 71, a slide rail 72, a fixed blade 73, a sheet passing portion 74, a moving blade 75, a slide holder 76, a drive pulley 77, a driven pulley 78, a pulley belt 79, and a cutting motor M1.

The cutter frame 71 extends in the axial direction. The slide rail 72 is a rail that is formed on the cutter frame 71 and extends in the axial direction. The fixed blade 73 is a flat plate-shaped blade that is fixed to the cutter frame 71 and extends in the axial direction. The sheet passing portion 74 is a space that is formed in the cutter frame 71 and through which the sheet S passes. In the present embodiment, the sheet passing portion 74 is formed between the slide rail 72 and the fixed blade 73. The moving blade 75 is a circular plate-shaped blade, and is rotatably fixed to the slide holder 76.

The slide holder 76 is engaged with the slide rail 72, and is slidably attached to the cutter frame 71 along the slide rail 72. The slide holder 76 is movable from an initial position indicated by a solid line to a cutting completion position indicated by a broken line in FIG. 2. Before the sheet S is cut, the slide holder 76 is located at the initial position indicated by the solid line in FIG. 2. When the slide holder 76 moves to the cutting completion position along the slide rail 72, one sheet S is sandwiched between the fixed blade 73 and the moving blade 75 and is cut into two portions. The slide holder 76 is returned from the cutting completion position to the initial position before the next sheet S starts to be cut.

The drive pulley 77 is disposed on the other side of the cutter frame 71 in the axial direction. The drive pulley 77 can rotate in forward and reverse directions by receiving a drive force of the cutting motor M1.

The driven pulley 78 is disposed on one side of the cutter frame 71 in the axial direction. The pulley belt 79 is wound around the drive pulley 77 and the driven pulley 78. Further, the slide holder 76 is fixed to the pulley belt 79. As a result, the slide holder 76 slides in the axial direction in accordance with the rotation of the pulley belt 79. In detail, when the cutting motor M1 is rotated in the forward direction, the slide holder 76 slides from one side to the other side in the axial direction, and when the cutting motor M1 is rotated in the reverse direction, the slide holder 76 slides from the other side to one side in the axial direction.

When cutting the sheet S, the cutter 7 rotates the cutting motor M1 in the forward direction to move the slide holder 76 located at the initial position toward the cutting completion position.

Then, the moving blade 75 moves together with the slide holder 76, and thus the sheet S located at the sheet passing portion 74 is sandwiched between the fixed blade 73 and the moving blade 75 and is cut.

When the slide holder 76 is located at the cutting completion position, the cutting motor M1 stops. After the cut sheet S is discharged, the cutting motor M1 rotates in the reverse direction, and the slide holder 76 is returned from the cutting completion position to the initial position.

Returning to FIG. 1, the sheet conveying unit 8 has a function of conveying the sheet S on which the image is formed to the outside of the apparatus main body 2 or to the image forming unit again. The sheet conveying unit 8 includes a first conveying path 81, the second conveying path 82, a re-conveying path 83, the first discharge roller 84, the second discharge roller 85, the switchback roller 86 as an example of a conveying roller, and a flapper 87.

The first conveying path 81 is a path for guiding the sheet S on which the image is formed to the outside of the apparatus main body 2.

Specifically, the first conveying path 81 is a path from the flapper 87 to the first discharge port 23.

In the present embodiment, the sheet S, which is not cut by the cutter 7, passes through the first conveying path 81.

The second conveying path 82 is a path different from the first conveying path 81. The second conveying path 82 is a path for guiding a sheet on which an image is formed by the image forming unit to the outside of the apparatus main body. Specifically, the second conveying path 82 is a path from the flapper 87 to the second discharge port 24. In the present embodiment, the sheet, which is cut by the cutter 7, mainly passes through the second conveying path 82. The second conveying path 82 is a conveying path longer than the first conveying path 81. More specifically, the first conveying path 81 and the second conveying path 82 are curved in the conveying direction, and the sheet S is discharged from the first discharge port 23 or the second discharge port 24 in the conveying direction opposite to a conveying direction of the sheet S that has passed through a fixing unit 6. In addition, the first conveying path 81 is disposed on an inner side of a curved portion with respect to the second conveying path 82, and the second discharge roller 85 as a discharge port of the second conveying path 82 and the cutter 7 are located above the first discharge roller 84 as a discharge port of the first conveying path 81. Further, the second discharge roller 85 is located downstream of the first discharge roller 84 in the discharge direction. Therefore, a distance by which the sheet S discharged from a nip portion NP of the fixing unit 6 is conveyed until the sheet S is discharged from the second discharge roller 85 of the second conveying path 82 is larger than a distance by which the sheet S is conveyed until the sheet S is discharged from the first discharge roller 84 of the first conveying path 81. As shown in FIG. 4, in the present embodiment, the conveying distance D1 by which the sheet S is conveyed from the nip portion NP to the cutter 7 refers to a distance by which the sheet is conveyed from the nip portion NP to the fixed blade 73 of the cutter 7 in the conveying direction. When the nip portion NP is formed in a nip state having a length in the conveying direction, the conveying distance D1 is preferably determined as a distance from the most downstream end of the nip portion NP in the conveying direction. Further, the second conveying path 82 has a space in a direction (a thickness direction of the sheet) orthogonal to the plane of the sheet S to be conveyed. Therefore, depending on the thickness and type of the sheet S, the portion of the second conveying path 82 in the thickness direction of the sheet S, which is to be passed through, is different. Therefore, regarding the conveying distance D1 by which the sheet S is conveyed from the nip portion NP to the cutter 7, it is preferable to define the conveying distance D1 in consideration of, for example, a case in which the amount of conveyance is the largest. However, in a case in which a variation in the amount of conveyance is small, the conveying distance D1 may be defined based on the shortest distance in design from the nip portion NP to the cutter 7.

As shown by the sheet S that is indicated by the broken line in FIG. 1, the re-conveying path 83 is a path for guiding the sheet that has passed through the fixing unit 6 to the image forming unit again. Specifically, the re-conveying path 83 is a path from the flapper 87 to the drum cartridge 5 through below the fixing unit 6.

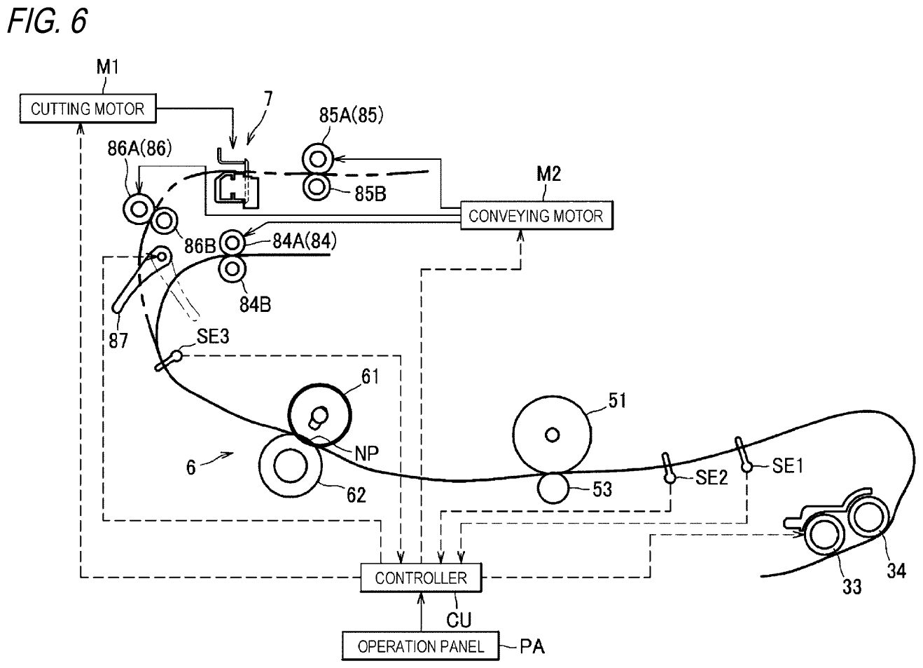

The first discharge roller 84 is a roller that is disposed in the first conveying path 81 and discharges the sheet S to the outside of the apparatus main body 2. In the present embodiment, the first discharge roller 84 refers to a roller pair arranged in an up-down direction, and includes a drive roller 84A and a driven roller 84B. The first discharge roller 84 is rotatable about an axis parallel to the axial direction. The first discharge roller 84 discharges the sheet S, which is not cut by the cutter 7, to the outside of the apparatus main body 2. The first discharge roller 84 is located closer to the fixing unit 6 than the second discharge roller 85. The first discharge roller 84 is rotatable by driving of a conveying motor M2 (see FIG. 6).

The second discharge roller 85 is a roller that is disposed in the second conveying path 82 and discharges the sheet S to the outside of the apparatus main body 2. In the present embodiment, the second discharge roller 85 refers to a roller pair arranged in the up-down direction, and includes a drive roller 85A and a driven roller 85B. The second discharge roller 85 is rotatable in the axial direction. The second discharge roller 85 mainly discharges the sheet S, which is cut by the cutter 7, to the outside of the apparatus main body 2. The second discharge roller 85 is located above and downstream of the first discharge roller 84 in the discharge direction of the sheet S. The second discharge roller 85 is rotatable by the driving of the conveying motor M2. A conveying speed of the sheet S by the second discharge roller 85 is higher than a conveying speed by the switchback roller 86.

The switchback roller 86 is a roller that is disposed in the second conveying path 82 and conveys the sheet S. The switchback roller 86 is located between the flapper 87 and the cutter 7. In the present embodiment, the switchback roller 86 refers to a roller pair, and includes a drive roller 86A and a driven roller 86B. The switchback roller 86 is rotatable in the forward and reverse directions by the driving of the conveying motor M2. When the conveying motor M2 rotates in the forward direction, the switchback roller 86 conveys the sheet S having passed through the flapper 87 toward the cutter 7. Further, when the conveying motor M2 rotates in the reverse direction, the switchback roller 86 conveys the sheet S located in the second conveying path 82 to the re-conveying path 83.

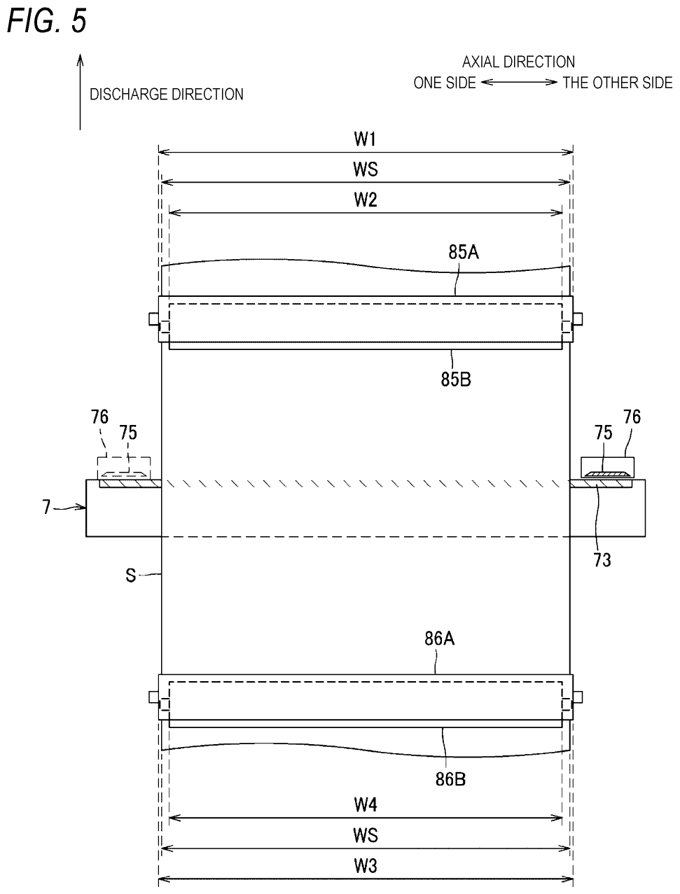

As shown in FIG. 5, a dimension W1 of the drive roller 85A of the second discharge roller 85 in the axial direction is larger than half of a width WS of the sheet S having a maximum width and capable of being conveyed by the image forming apparatus 1 (W1>WS/2). In the present embodiment, the maximum width by which the sheet S can be conveyed by the image forming apparatus 1 is 215.9 mm.

Similarly, a dimension W2 of the driven roller 85B of the second discharge roller 85 in the axial direction is larger than half of the width WS of the sheet having the maximum width and capable of being conveyed by the image forming apparatus 1 (W2>WS/2).

Further, the dimension W1 of the drive roller 85A of the second discharge roller 85 in the axial direction is larger than the width WS of the sheet S having the maximum width and capable of being conveyed by the image forming apparatus 1 (W1>WS). Further, the dimension W2 of the driven roller 85B of the second discharge roller 85 in the axial direction is smaller than the width WS of the sheet S having the maximum width and capable of being conveyed by the image forming apparatus 1 (W2<WS).

A dimension W3 of the drive roller 86A of the switchback roller 86 in the axial direction is larger than half of the width WS of the sheet S having the maximum width and capable of being conveyed by the image forming apparatus 1 (W3>WS/2).

Similarly, a dimension W4 of the driven roller 86B of the switchback roller 86 in the axial direction is larger than half of the width WS of the sheet having the maximum width and capable of being conveyed by the image forming apparatus 1 (W4>WS/2). Further, the dimension W3 of the drive roller 86A of the switchback roller 86 in the axial direction is larger than the width WS of the sheet S having the maximum width and capable of being conveyed by the image forming apparatus 1 (W3>WS). Further, the dimension W4 of the driven roller 86B of the switchback roller 86 in the axial direction is smaller than the width WS of the sheet S having the maximum width and capable of being conveyed by the image forming apparatus 1 (W4<WS).

The flapper 87 is located at a branch portion between the first conveying path 81 and the second conveying path 82. The flapper 87 is movable between a first position indicated by a solid line in FIG. 1 and a second position indicated by a two-dot chain line in FIG. 1. When the flapper 87 is located at the first position, the flapper 87 guides the sheet S having passed through the fixing unit 6 to the first conveying path 81. When the flapper 87 is located at the second position, the flapper 87 guides the sheet S having passed through the fixing unit 6 to the second conveying path 82.

The sensor SE is a sensor that is disposed in a conveying path of the sheet S and is capable of detecting the presence or absence of the sheet S. Specifically, the sensor SE includes a first sensor SE1, a second sensor SE2, and a third sensor SE3. The first sensor SE1 is located between the separation roller 34 and the registration roller 35 in the conveying direction of the sheet. The first sensor SE1 is located immediately in front of the registration roller 35. The second sensor SE2 is located between the registration roller 35 and the photosensitive drum 51 in the conveying direction of the sheet. The third sensor SE3 is located between the fixing unit 6 and the flapper 87 in the conveying direction of the sheet.

The operation panel PA is located on an outer surface of the apparatus main body 2. The operation panel PA allows a user to input a command to form an image, a command to cut the sheet S, and the like. In the present embodiment, for example, the operation panel PA allows to input a cutting point of the sheet S.

The controller CU includes a central processing unit (CPU), a random access memory (RAM), a read only memory (ROM) and an input-output circuit, and controls the image forming apparatus 1 by performing various arithmetic processes based on programs and data stored in the ROM and the like.

As shown in FIG. 6, the controller CU is electrically connected to the first sensor SE1, the second sensor SE2, and the third sensor SE3, and can receive respective detection signals thereof. The controller CU controls the pickup roller 33, the cutting motor M1, the conveying motor M2, and the flapper 87 based on information received from the operation panel PA and the receive sensors.

In principle, the controller CU conveys the sheet S to the first conveying path 81 when the sheet S is not cut by the cutter 7, and conveys the sheet S to the second conveying path 82 when the sheet S is cut by the cutter 7.

When the sheet S is conveyed to the cutter 7, the controller CU starts to rotate the switchback roller 86 after a leading end of the sheet S in the conveying direction comes into contact with the switchback roller 86. Specifically, the controller CU receives a detection signal indicating that the third sensor SE3 detects the leading end of the sheet S. After a predetermined time has elapsed from the reception of the detection signal of the third sensor SE3, the controller CU rotates the conveying motor M2 in the forward direction, and starts the rotation of the switchback roller 86. The predetermined time is a time sufficient for the leading end of the sheet S to come into contact with the switchback roller 86 and the skew of the sheet S to be corrected.

As shown in FIG. 4, when the command to cut the sheet S is received, the controller CU causes the cutter 7 to cut the sheet S in a case in which a dimension L1 in the conveying direction from an expected cutting point PP of the sheet S to a trailing end position of the sheet S is smaller than the conveying distance D1 of the sheet S from the nip portion NP to the cutter 7. That is, the controller CU does not cut the sheet S by the cutter 7 in a case in which the dimension L1 in the conveying direction from the expected cutting point PP of the sheet S to the trailing end position of the sheet S is equal to or larger than the conveying distance D1 of the sheet S from the nip portion NP to the cutter 7.

The controller CU cuts the sheet S based on the command input to the operation panel PA. Specifically, when the command to cut the sheet S is received, the controller CU cuts the sheet S by the cutter 7 in a state in which the conveyance of the sheet S stops. As an example, when a command to cut the sheet S having the letter size and having the dimension of 215.9 mm in the conveying direction in half is received, two sheets S having the dimension of 139.7 mm in the conveying direction are acquired after the cutting.

The controller CU can acquire the dimension of the sheet S in the conveying direction based on the detection signal from the sensor SE. Specifically, the controller CU may calculate the dimension of the sheet S in the conveying direction based on a passage time during which the sheet S passes through the first sensor SE1. In the present embodiment, the controller CU acquires the dimension of the sheet S based on the detection signal from the first sensor SE1, and may acquire the dimension of the sheet S based on detection signals from other sensors (the second sensor SE2, the third sensor SE3, and the like).

When determining that the dimension of the sheet S in the conveying direction is smaller than a predetermined value based on the detection signal from the sensor SE, the controller CU conveys the sheet S to the second conveying path 82 and discharges the sheet S to the outside of the apparatus main body 2 without cutting the sheet S.

Further, when determining that the dimension of the sheet S in the conveying direction of the sheet included in a received print job (hereinafter, simply referred to as a “job”) is smaller than the predetermined value, the controller CU conveys the sheet S to the second conveying path 82 and discharges the sheet S to the outside of the apparatus main body 2 without cutting the sheet S.

As described above, when the controller CU determines that the dimension of the sheet S in the conveying direction is smaller than the predetermined value based on the detection signal from the sensor SE or information on the received job, the sheet S is conveyed to the second conveying path 82 even when the sheet S is not cut by the cutter 7.

When a command to cut a plurality of sheets S is received, the controller CU starts to feed the next sheet S before the cutting of the preceding sheet S is completed. The controller CU starts to feed the sheets S by driving the pickup roller 33. When the command to cut a plurality of sheets S is received, the controller CU conveys the sheets S at a predetermined interval between the trailing end of the preceding sheet S and the leading end of the next sheet S.

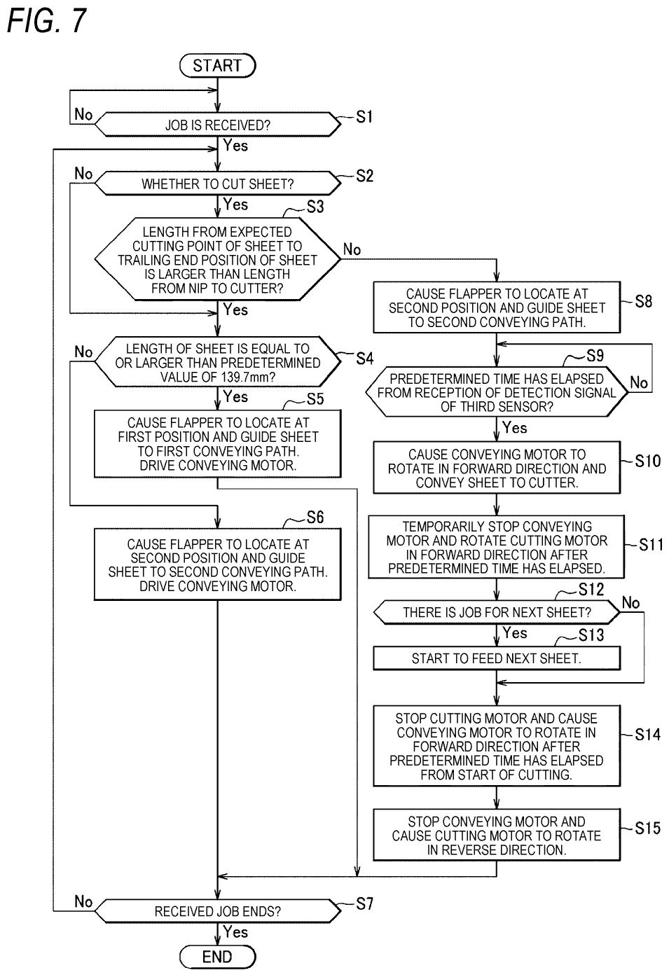

Next, an example of a process executed by the controller CU that receives the job will be described with reference to FIG. 7.

When determining that the job is received (S1, Yes), the controller CU determines whether to cut the sheet S based on the command input from the operation panel PA or the information on the job (S2).

In step S2, when determining to cut the sheet S (S2, Yes), the controller CU determines whether the dimension L1 from the expected cutting point PP to the trailing end position of the sheet S is larger than the D1 serving as the distance from the nip portion NP to the cutter 7 and stored in the ROM and the like (L1>D1?) (S3).

When not determining to cut the sheet S in step S2 (S2, No), or when determining in step S3 that the dimension L1 from the expected cutting point PP to the trailing end position of the sheet S is larger than the conveying distance D1 from the nip portion NP to the cutter 7 (L1>D1) (S3, Yes), the controller CU determines whether the dimension of the sheet S is equal to or larger than the predetermined value (the dimension of 139.7 mm which is half of the letter size) (S4). Methods of determining the dimension of the sheet S by the controller CU include a method of determining the dimension based on the information on the received job and a method of acquiring the dimension of the sheet S based on a detection result of the sensor SE.

When determining in step S4 that the dimension of the sheet S in the conveying direction is equal to or larger than the predetermined value (137.9 mm) (S4, Yes), the controller CU causes the flapper 87 to locate at the first position, guides the sheet S to the first conveying path 81, and rotates the conveying motor M2 in the forward direction (S5). As a result, the first discharge roller 84 is driven to discharge the sheet from the first discharge port 23.

The controller CU determines whether the received job ends (S7) after step S5, the controller CU ends the process when the received job ends (S7, Yes), and returns to step S2 when the received job does not end (S7, No).

When not determining in step S4 that the dimension of the sheet S in the conveying direction is equal to or larger than the predetermined value (137.9 mm) (S4, No), the controller CU causes the flapper 87 to locate at the second position, guides the sheet S to the second conveying path 82, and rotates the conveying motor M2 in the forward direction (S6).

The controller CU determines whether the received job ends (S7) after step S6, the controller CU ends the process when the received job ends (S7, Yes), and returns to step S2 when the received job does not end (S7, No).

On the other hand, when determining in step S3 that the dimension L1 from the expected cutting point PP to the trailing end position of the sheet S is not larger than the conveying distance D1 from the nip portion NP to the cutter 7 (L1≤D1) (S3, No), the controller CU causes the flapper 87 to locate at the second position and guides the sheet S to the second conveying path 82 (S8).

After step S8, the controller CU determines whether the predetermined time has elapsed from the reception of the detection signal of the third sensor SE3 (S9).

When not determining in step S9 that the predetermined time has elapsed from the reception of the detection signal of the third sensor SE3 (S9, No), the controller CU waits until the predetermined time elapses from the reception of the detection signal of the third sensor SE3. When the predetermined time elapses from the reception of the detection signal of the third sensor SE3, the leading end of the sheet S comes into contact with the switchback roller 86 and the skew is corrected.

When determining that the predetermined time has elapsed from the reception of the detection signal of the third sensor SE3 (S9, Yes), the controller CU drives the conveying motor M2 to rotate in the forward direction. As a result, the switchback roller 86 is caused to rotate in the forward direction and convey the sheet S to the cutter 7 (S10).

After step 10, when the expected cutting point PP of the sheet S reaches the cutter 7 after a predetermined time has elapsed from the start of the rotation of the conveying motor M2 in the forward direction, the conveying motor M2 is temporarily stopped and the cutting motor M1 is rotated in the forward direction (S11).

After step S11, the controller CU determines whether there is a job for the next sheet S (S12), and when determining that there is a job for the next sheet S (S12, Yes), the controller CU starts to feed the next sheet S (S13) and the process proceeds to S14. When not determining that there is a job for the next sheet S (S12, No), the process proceeds to S14 without feeding the next sheet S.

After step S12 or step S13, the controller CU stops the cutting motor M1 and causes the conveying motor M2 to rotate in the forward direction after a predetermined time has elapsed from the start of the cutting (S14). As a result, the slide holder 76 of the cutter 7 stops at the cutting completion position, and the sheet S is discharged by the second discharge roller 85.

After step S14, the controller CU stops the conveying motor M2 and causes the cutting motor M1 to rotate in the reverse direction (S15). As a result, the slide holder 76 of the cutter 7 returns to the initial position.

The controller CU determines whether the received job ends (S7) after step S15, the controller CU ends the process when the received job ends (S7, Yes), and returns to step S2 when the received job does not end (S7, No).

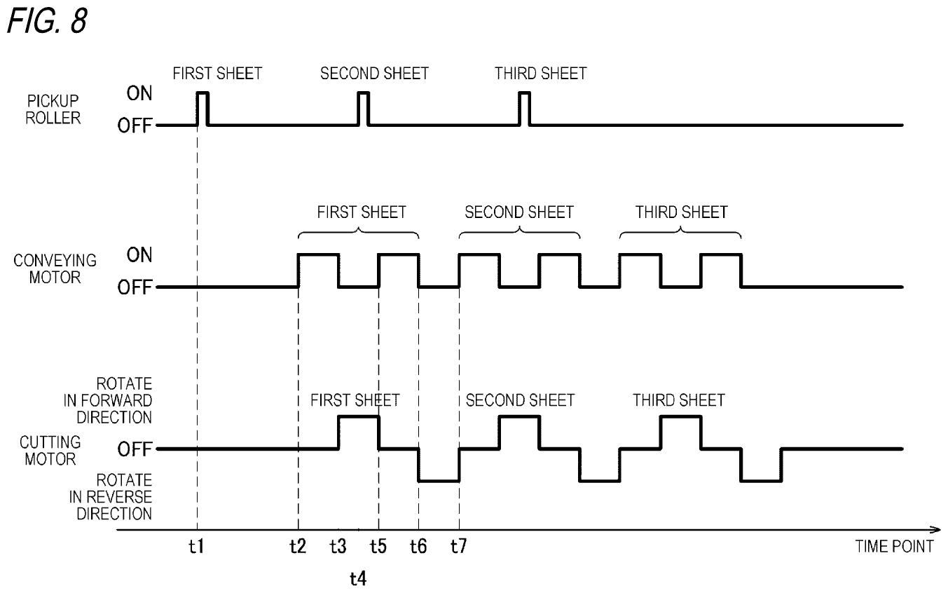

Next, an operation of picking up the sheets S, an operation of conveying the sheets S by the conveying motor M2 (the switchback roller 86 and the second discharge roller 85), and an operation of cutting the sheets S by the cutting motor M1 when a job to cut the plurality of sheets S is received will be described with reference to FIG. 8.

The controller CU drives the pickup roller 33 and starts to feed the first sheet S (at a time point t1). The fed first sheet S is subjected to the image formation and is conveyed toward the cutter 7.

After the predetermined time has elapsed from the reception of the detection signal of the third sensor SE3, the controller CU causes the conveying motor M2 to rotate in the forward direction and conveys the sheet S to the cutter 7 (at a time point t2).

After the predetermined time has elapsed from the start of the rotation of the conveying motor M2 in the forward direction, the controller CU temporarily stops the conveying motor M2 and causes the cutting motor M1 to rotate in the forward direction (at a time point t3). As a result, the cutting is started in the state in which the sheet S stops.

After the cutting motor M1 is rotated in the forward direction and before the cutting of the sheet S is completed, the controller CU drives the pickup roller 33 and starts to feed the second sheet S (at a time point t4). In this way, the conveyance of the second sheet S is started during the cutting of the first sheet S.

After the predetermined time has elapsed from the start of the cutting, the controller CU stops the cutting motor M1 and causes the conveying motor M2 to rotate in the forward direction (at a time point t5). As a result, the cut portions of the first sheet S are discharged.

After a predetermined time has elapsed from the time point t5, the controller CU stops the conveying motor M2 and causes the cutting motor M1 to rotate in the reverse direction (at a time point t6). As a result, the slide holder 76 of the cutter 7 starts to move from the cutting completion position toward the initial position.

When the slide holder 76 returns to the initial position after a predetermined time has elapsed from the time point t6, the controller CU stops the cutting motor M1 (at a time point t7). At this time, when a predetermined time has elapsed from the reception of the detection signal for the second sheet S from the third sensor SE3, the conveying motor M2 is rotated in the forward direction at the same time, and when the predetermined time does not elapse, the conveying motor M2 waits until the predetermined time has elapsed and then is rotated in the forward direction.

Regarding the second and third sheets S, the controller CU also performs the conveying operation and the cutting operation at the same timing as the first sheet S.

From the above, the following effects can be achieved according to the present embodiment.

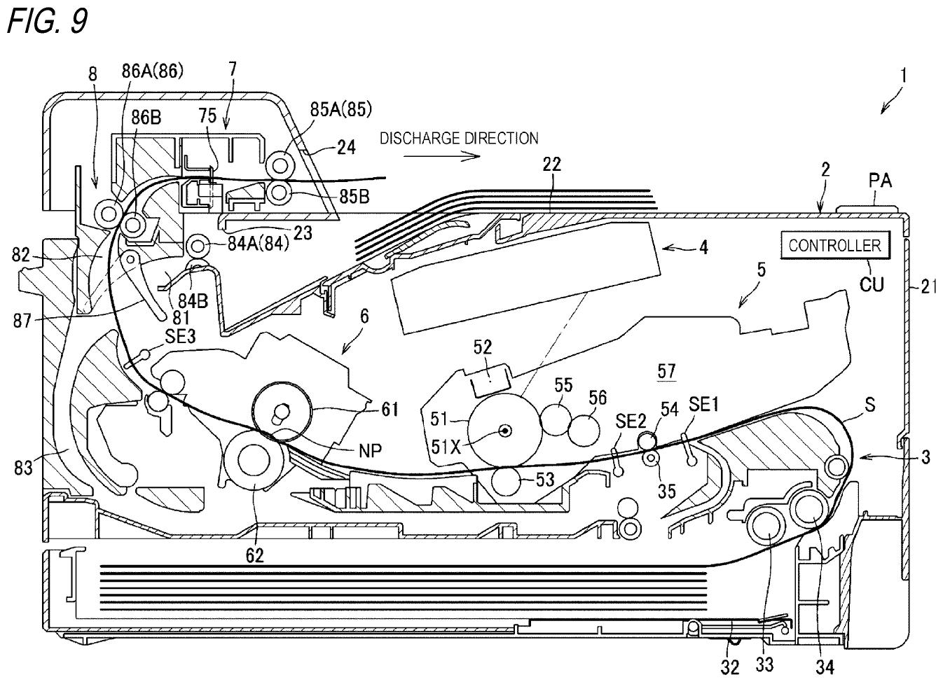

In the image forming apparatus 1, the second discharge roller 85 is located downstream of the first discharge roller 84 in the discharge direction. Therefore, as shown in FIG. 9, the cut sheet S is discharged downstream of the uncut sheet S in the discharge direction. Accordingly, the cut sheet S is easily taken.

Further, the second discharge port 24 is located downstream of the first discharge port 23 in the discharge direction. Therefore, the cut sheet is discharged downstream of the uncut sheet S in the discharge direction. Accordingly, the cut sheet S is easily taken.

In addition, the image forming apparatus 1 includes the flapper 87 that can move to the first position at which the sheet S having passed through the fixing unit 6 is guided to the first conveying path 81 and the second position at which the sheet S having passed through the fixing unit 6 is guided to the second conveying path 82. Therefore, the sheet S can be guided to either the first conveying path 81 or the second conveying path 82 by the flapper 87.

Here, since the cutter 7 cuts the sheet S in a state in which the trailing end of the sheet S has passed through the fixing unit 6, the cutter 7 is located at a predetermined distance or more from the fixing unit 6. Therefore, when the first discharge roller 84 is located farther from the fixing unit 6 than the second discharge roller 85 that discharges the cut sheet S, the size of the apparatus main body increases. However, in the present embodiment, the first discharge roller 84 is located closer to the fixing unit 6 than the second discharge roller 85, and thus it is possible to restrain the increase in size of the apparatus main body 2. Similarly, the first discharge port 23 is located closer to the fixing unit 6 than the second discharge port 24, and thus it is possible to reduce the size of the apparatus main body 2.

Further, the dimensions W1 and W2 of the second discharge roller 85 in the axial direction and the dimensions W3 and W4 of the switchback roller 86 in the axial direction are larger than the half WS/2 of the width of the sheet S having the maximum width and capable of being conveyed by the image forming apparatus 1 (W1>WS/2, W2>WS/2, W3>WS/2, and W4>WS/2). Therefore, at the time of cutting the sheet S, the second discharge roller 85 and the switchback roller 86 hold the sheet S in a wide region in the width direction, so that it is possible to restrain positional deviation of the sheet S at the time of cutting.

Further, at least one of the dimension W1 of the second discharge roller 85 in the axial direction and the dimension W3 of the switchback roller 86 in the axial direction is larger than the width WS of the sheet S having the maximum width and capable of being conveyed by the image forming apparatus 1. Therefore, at the time of cutting the sheet S, the second discharge roller 85 or the switchback roller 86 hold the sheet S in the wide region in the width direction, so that it is possible to restrain the positional deviation of the sheet S at the time of cutting.

Further, when acquiring the dimension of the sheet S in the conveying direction and determining that the dimension of the sheet S in the conveying direction is smaller than the predetermined value (139.7 mm) based on the detection signal from the sensor SE or the information on the job, the controller CU conveys the sheet S to the second conveying path 82 and discharges the sheet S to the outside of the apparatus main body 2 without cutting the sheet S. Therefore, when the small-sized sheet S is discharged, the sheet S is discharged through the second conveying path 82, and thus the small-sized sheet S is easily taken.

In addition, as shown in FIG. 4, the conveying distance D1 by which the sheet S is conveyed from the nip portion NP to the cutter 7 is larger than half of the dimension LS (279.4 mm) of the sheet S having the letter size in the conveying direction (D1>LS/2=139.7 mm). Therefore, the sheet S can be cut in a state in which the entire sheet S having the letter size has passed through the nip portion NP. Accordingly, even when the sheet S is cut in the state in which the conveyance of the sheet S stops, it is possible to restrain the sheet S from being heated and pressurized more than necessary at the nip portion NP.

Further, when the command to cut the sheet S is received, the controller CU cuts the sheet S in the state in which the conveyance of the sheet S stops. Therefore, the sheet S can be cut straight in the axial direction.

Further, when the command to cut the sheet S is received, the controller CU cuts the sheet S by the cutter 7 in the case in which the dimension L1 in the conveying direction from the expected cutting point PP of the sheet S to the trailing end position of the sheet S is smaller than the conveying distance D1 of the sheet from the nip portion NP to the cutter 7. Accordingly, the controller CU does not cut the sheet S by the cutter 7 in the case in which the dimension L1 in the conveying direction from the expected cutting point PP of the sheet S to the trailing end position of the sheet S is equal to or larger than the conveying distance D1 of the sheet S from the nip portion NP to the cutter 7, and thus it is possible to restrain the sheet S from being heated and pressurized more than necessary at the nip portion NP.

Further, when the sheet S is conveyed to the cutter 7, the controller CU starts to rotate the switchback roller 86 after the leading end of the sheet S in the conveying direction comes into contact with the switchback roller 86. Therefore, even when the sheet S is conveyed in a skewed manner with respect to the conveying direction, it is possible to restrain the skew by bringing the sheet S into contact with the switchback roller 86.

The conveying speed by the second discharge roller 85 is higher than the conveying speed by the switchback roller 86.

Therefore, when the sheet S is in contact with both the second discharge roller 85 and the switchback roller 86, the sheet S is pulled by the second discharge roller 85 and the switchback roller 86, and thus it is possible to restrain the slackness of the sheet S between the switchback roller 86 and the second discharge roller 85. Further, after the sheet S is cut, it is possible to restrain the cut sheets S from coming into contact with each other and restrain the sheets from interfering with each other.

In addition, when the command to cut a plurality of sheets S is received, the controller CU starts to feed the next sheet S before the cutting of the preceding sheet S is completed. Therefore, even when the plurality of sheets are cut, it is possible to restrain the completion of the work from being delayed.

Further, when the command to cut a plurality of sheets S is received, the controller CU conveys the sheets S at the predetermined interval between the trailing end of the preceding sheet S and the leading end of the next sheet S. Therefore, it is possible to restrain the interference between the preceding sheet S and the next sheet S.

Although the embodiment according to the present disclosure has been described above, the present disclosure is not limited to the embodiment. The specific configuration can be appropriately changed without departing from the gist of the present disclosure.

In the above embodiment, the sheets S discharged from the first discharge port 23 and the second discharge port 24 are placed on one discharge tray 22, but the present disclosure is not limited to this configuration.

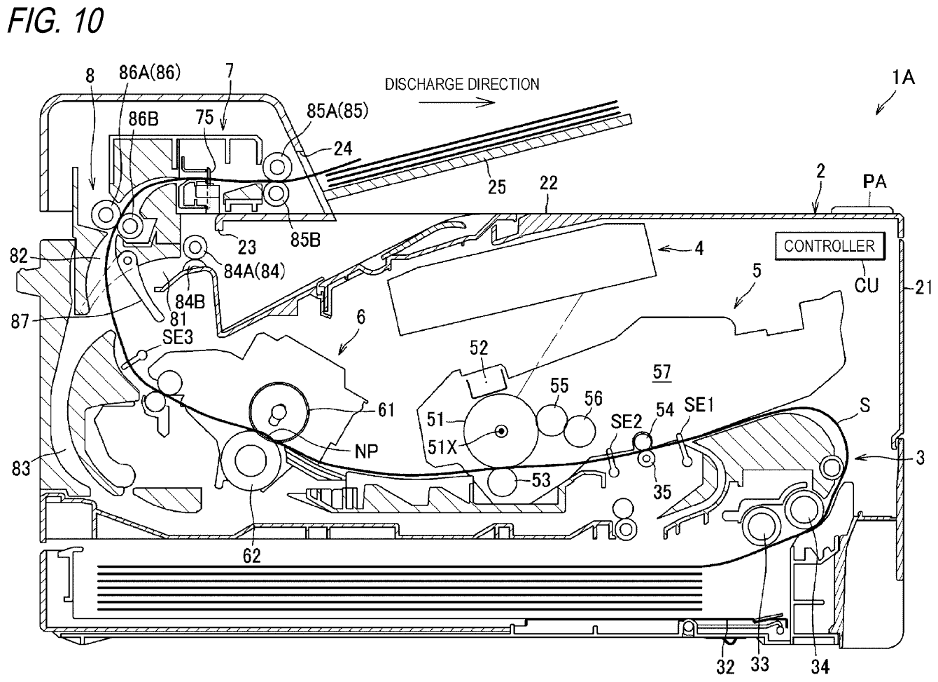

For example, an image forming apparatus 1A shown in FIG. 10 includes the discharge tray 22 as an example of a first discharge tray and a second discharge tray 25. The sheet S discharged through the first conveying path 81 can be stacked on the discharge tray 22. The sheet S discharged through the second conveying path 82 can be stacked on the second discharge tray 25. The second discharge tray 25 is provided outside the second discharge port 24. Therefore, in the image forming apparatus 1A, the sheet S discharged from the first conveying path 81 and the sheet S discharged from the second conveying path 82 can be housed in different trays. Accordingly, the cut sheet S is easily taken.

Although in the above embodiment, the sheets S discharged from the first discharge port 23 and the second discharge port 24 are placed on the discharge tray 22, a configuration not including a discharge tray may be adopted. Although not shown, for example, the sheets S discharged from the first discharge port 23 and the second discharge port 24 may be directly discharged onto a desk, a floor, or the like, and the sheets S may be placed on the desk, the floor, or the like.

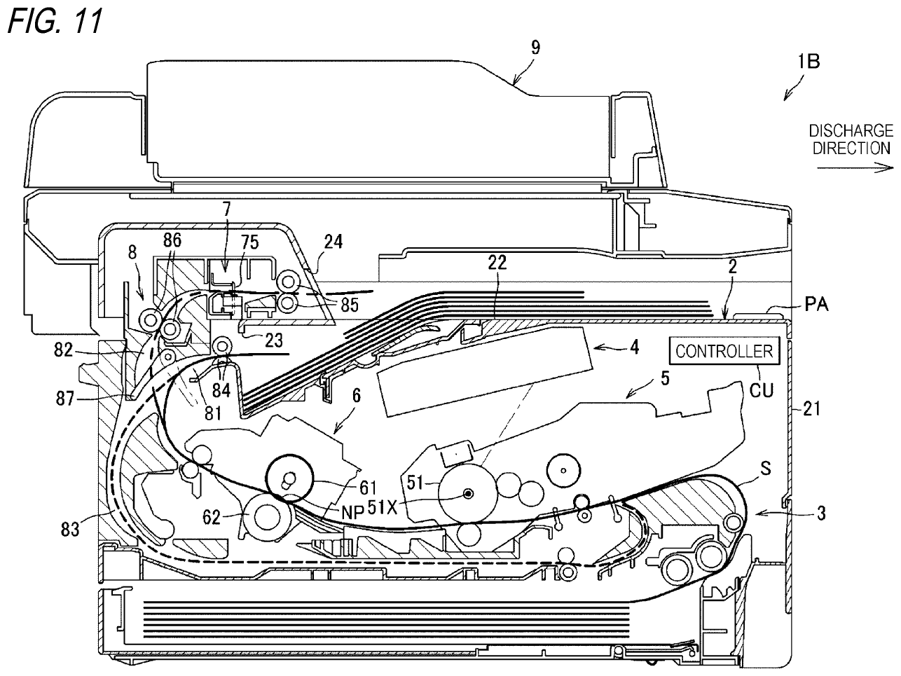

In the above embodiment, the image forming apparatus 1 does not include a scanner unit, but the present disclosure is not limited to this configuration. For example, an image forming apparatus 1B shown in FIG. 11 further includes a scanner unit 9. The scanner unit 9 is a device for reading a character or an image on the sheet S or the like. In the image forming apparatus 1B, the scanner unit 9 is disposed above the discharge tray 22, and thus a gap for taking out the sheet S is narrow, and if the cut sheet S is discharged to the same position as the uncut sheet S, it is very difficult to take the sheet S. However, since the second discharge roller 85 is located downstream of the first discharge roller 84 in the discharge direction and the second discharge port 24 is located downstream of the first discharge port 23 in the discharge direction, the cut sheet S is discharged downstream of the uncut sheet S in the conveying direction, thereby making it easier to take the cut sheet S.

Although in the above embodiment, the conveying distance D1 by which the sheet S is conveyed from the nip portion NP to the cutter 7 is larger than the half (139.7 mm) of the dimension LS of the sheet S having the letter size in the conveying direction, the sheet S having a size other than the letter size may be a reference.

For example, with reference to the A4 size (210 mm×297 mm), the conveying distance D1 by which the sheet S is conveyed from the nip portion NP to the cutter 7 may be larger than the half (148.5 mm) of the dimension LS of the sheet S having the A4 size in the conveying direction.

Accordingly, in addition to the letter size, the sheet S can be cut in a state in which the entire sheet S having the A4 size has passed through the nip portion NP. Accordingly, even when the sheet S is cut in the state in which the conveyance of the sheet S stops, it is possible to restrain the sheet S from being heated and pressurized more than necessary at the nip portion NP. In other words, the fixing unit 6 and the cutter 7 are disposed such that the conveying distance D1 by which the sheet S is conveyed from the nip portion NP to the cutter 7 is larger than half of the dimension of the sheet to be cut in the conveying direction.

For example, with reference to the legal size (215.9 mm×355.6 mm), the conveying distance D1 by which the sheet S is conveyed from the nip portion NP to the cutter 7 may be larger than the half (177.8 mm) of the dimension LS of the sheet S having the legal size in the conveying direction.

Accordingly, the sheet S can be cut in a state in which the entire sheet S having the legal size has passed through the nip portion NP. Therefore, even when the sheet S is cut in the state in which the conveyance of the sheet S stops, it is possible to restrain the sheet S from being heated and pressurized more than necessary at the nip portion NP.

In the above embodiment, after the cutter 7 cuts one sheet S into two portions, the two portions are discharged immediately after the cutting, but the present disclosure is not limited to this configuration.

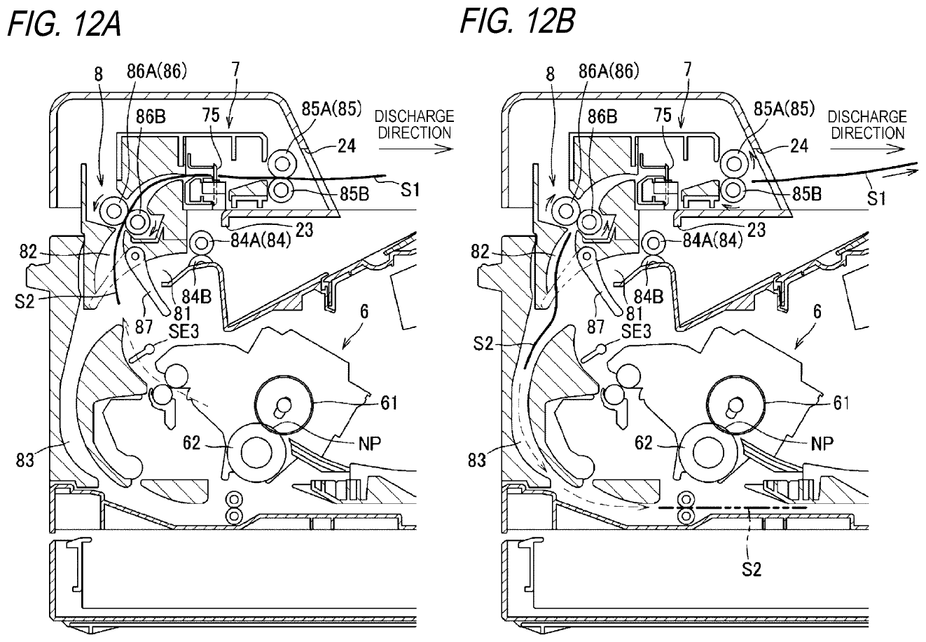

For example, as shown in FIGS. 12A and 12B, the controller CU may cause the cutter 7 to cut one sheet S into two portions (S1 and S2) and rotate the switchback roller 86 in the reverse direction so as to convey the sheet S2 on the upstream side in the conveying direction of the cut sheets S to the re-conveying path 83.

Specifically, as shown in FIG. 12A, the controller CU causes the cutter 7 to cut one sheet S into two portions (S1 and S2). As shown in FIG. 12B, the sheet S1 on the downstream side of the cut sheets S is discharged from the second discharge port 24 after the cutting. Of the cut sheets S, the sheet S2 on the upstream side is conveyed to the re-conveying path 83. Then, the sheet S2 on the upstream side is kept in the re-conveying path 83 as indicated by a two-dot chain line in FIG. 12B. When receiving a job corresponding to the sheet S2, the controller CU conveys the kept sheet S2 to the image forming unit and executes the image formation. When determining that the received job cannot be executed while the sheet S2 is kept in the re-conveying path 83, the controller CU discharges the sheet S2 without executing the image formation. As described above, in the embodiment shown in FIGS. 12A and 12B, the sheet S2 on the upstream side of the cut sheets S can be re-conveyed to the re-conveying path 83 and can be subjected to the image formation again.

In the above embodiment, the controller CU does not cut the sheet S when the dimension in the conveying direction from the expected cutting point PP of the sheet S to a trailing end position EN of the sheet is larger than the conveying distance D1 of the sheet S from the position of the nip portion NP to the cutter 7, but the present disclosure is not limited to this configuration.

For example, the controller CU may cut the sheet S even when the dimension in the conveying direction from the expected cutting point PP of the sheet S to the trailing end position EN of the sheet S is larger than the conveying distance D1 of the sheet S from the position of the nip portion NP to the cutter 7.

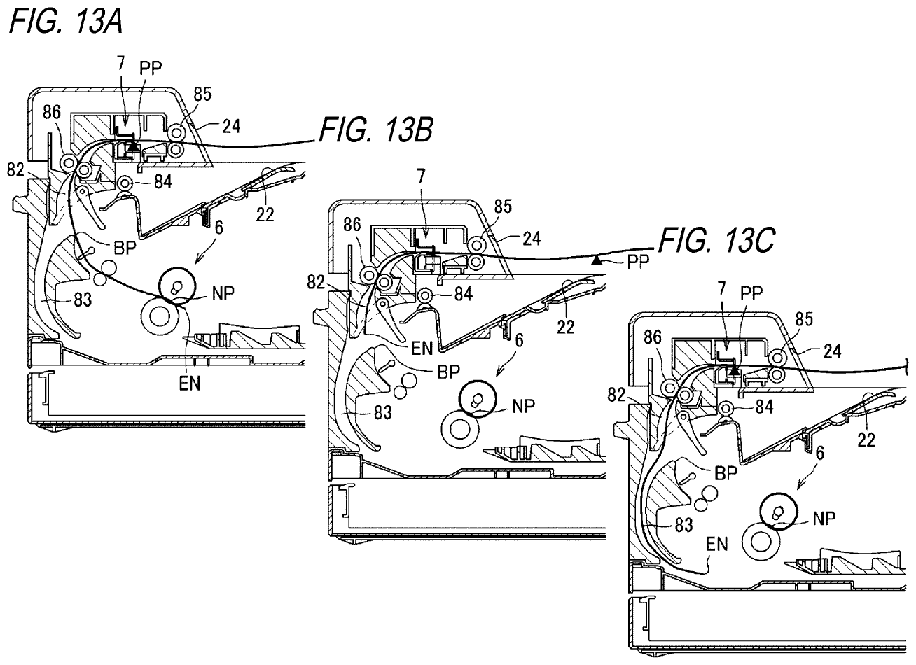

As shown in FIG. 13A, the controller CU executes a trailing end avoiding control when the dimension from the expected cutting point PP to the trailing end position EN of the sheet S is larger than the conveying distance D1. In FIGS. 13A to 13C, the expected cutting point PP is indicated by a black triangle.

In the trailing end avoiding control, as shown in FIG. 13B, the sheet S is conveyed until the expected cutting point PP of the sheet S is located downstream of the cutter 7 and a trailing end EN is located downstream of the path from the fixing unit 6 to the flapper 87 and a branch point BP of the re-conveying path. Then, as shown in FIG. 13C, the trailing end position EN of the sheet S enters the re-conveying path 83 by rotating the switchback roller 86 in the reverse direction, and the sheet S is cut in a state in which the trailing end position EN of the sheet S enters the re-conveying path.

Accordingly, even when the conveying distance D1 is smaller than the dimension from the expected cutting point PP of the sheet to the trailing end position EN of the sheet, the sheet S can be cut in a state in which the trailing end position EN of the sheet S has passed through the fixing unit 6. Therefore, when the cutter 7 cuts the expected cutting point PP of the sheet S, it is possible to restrain the sheet S from being sandwiched between the heating unit 61 and the pressure roller 62. As a result, it is possible to restrain an increase in the size of the image forming apparatus 1.

In the above embodiment, when the command to cut a plurality of sheets S is received, the controller CU starts to feed the next sheet S before the cutting of the preceding sheet S is completed, but the present disclosure is not limited to this configuration.

For example, when the command to cut a plurality of sheets S is received, the controller CU may move the moving blade 75 from the initial position in the width direction of the sheet S to cut the sheet S, and start to feed the next sheet S after the cutting of the preceding sheet S is completed and before the moving blade 75 reaches the initial position.

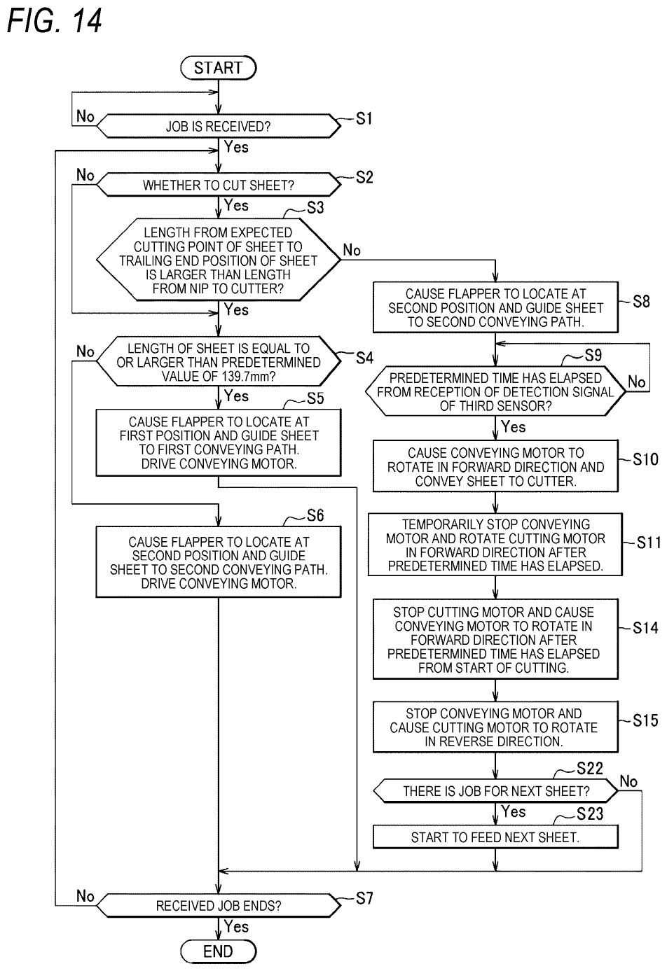

Specifically, as shown in FIG. 14, when there is a job for the next sheet S (S22, Yes) after the cutting motor M1 is rotated in the reverse direction in step S15, the controller CU starts to feed the next sheet S (S23). Then, when the slide holder 76 of the cutter 7 returns to the initial position after step S23, the controller CU stops the cutting motor M1.

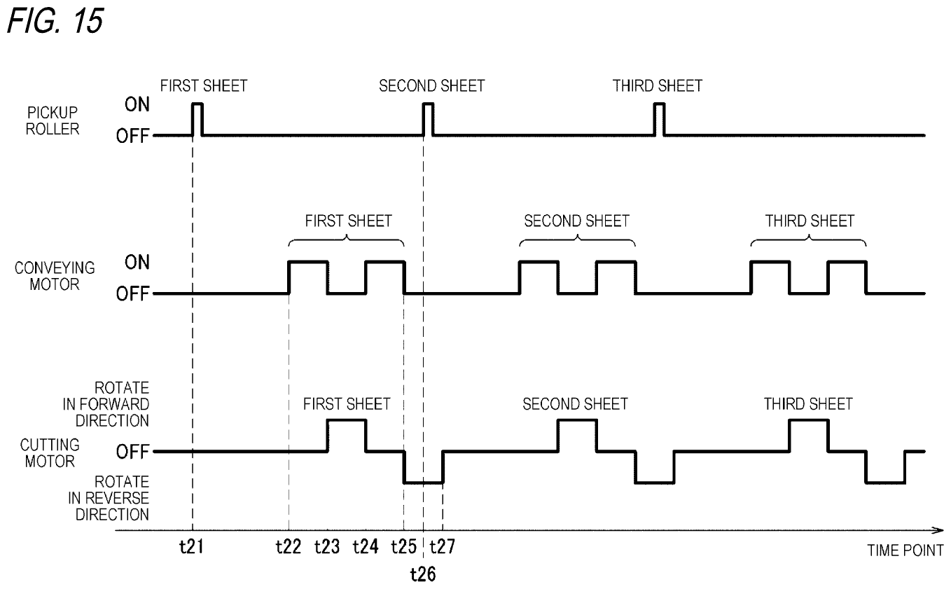

In this case, the operation of picking up the sheets S, the operation of conveying the sheets S by the conveying motor M2 (the switchback roller 86 and the second discharge roller 85), and the operation of cutting the sheets S by the cutting motor M1 when the job to cut the plurality of sheets S is received will be described with reference to FIG. 15.

The controller CU drives the pickup roller 33 and starts to feed the first sheet S (at a time point t21). The fed first sheet S is subjected to the image formation and is conveyed toward the cutter 7.

After the predetermined time has elapsed from the reception of the detection signal of the third sensor SE3, the controller CU causes the conveying motor M2 to rotate in the forward direction and conveys the sheet S to the cutter 7 (at a time point t22).

After the predetermined time has elapsed from the start of the rotation of the conveying motor M2 in the forward direction, the controller CU temporarily stops the conveying motor M2 and causes the cutting motor M1 to rotate in the forward direction (at a time point t23). As a result, the cutting is started in the state in which the sheet S stops.

After the predetermined time has elapsed from the start of the cutting, the controller CU stops the cutting motor M1 and causes the conveying motor M2 to rotate in the forward direction (at a time point t24). As a result, the cut portions of the first sheet S are discharged.

After a predetermined time has elapsed from the time point t24, the controller CU stops the conveying motor M2 and causes the cutting motor M1 to rotate in the reverse direction (at a time point t25). As a result, the moving blade 75 of the cutter 7 starts to move from the cutting completion position toward the initial position.

After the cutting motor M1 is rotated in the reverse direction and before the moving blade 75 reaches the initial position, the controller CU drives the pickup roller 33 and starts to feed the second sheet S (at a time point t26). In this way, the conveyance of the second sheet S is started during the movement of the moving blade 75.

When the slide holder 76 returns to the initial position after a predetermined time has elapsed from the time point t25, the controller CU stops the cutting motor M1 (at a time point t27).

Regarding the second and third sheets S, the controller CU also performs the conveying operation and the cutting operation at the same timing as the first sheet S.

Even in the above configuration, the conveyance of the next sheet S is started before the moving blade 75 reaches the initial position, and thus it is possible to restrain the completion of the work from being delayed even in the case of cutting the plurality of sheets S.

In the above embodiment, the cutter 7 is disposed in the second conveying path 82, but the present disclosure is not limited to this configuration. For example, the cutter 7 may be disposed between the flapper 87 and the fixing unit 6.

In the above embodiment, the operation panel PA is exemplified as the input unit, but a print command or a cutting command may be input via a computer or a network.

In the above embodiment, each of the first discharge roller 84, the second discharge roller 85, and the switchback roller 86 is a roller pair including two rollers, but the present disclosure is not limited thereto, and each of the first discharge roller 84, the second discharge roller 85, and the switchback roller 86 may be implemented by one roller, or may include three or more rollers.

In the above embodiment, the maximum width by which the sheet S can be conveyed by the image forming apparatus 1 is set to 215.9 mm by using the letter size (215.9 mm×279.4 mm) as an example, but the present disclosure is not limited to this dimension, the A4 size (210 mm×297 mm) and the A3 size (297 mm×420 mm) may be used as a reference.

In the above embodiment, the image forming apparatus is a laser printer that forms a monochrome image, but the present disclosure is not limited thereto. For example, the image forming apparatus may be a printer that forms a color image. Further, the image forming apparatus is not limited to the printer. For example, the image forming apparatus may be a copier, a multi-function device, and the like.

The elements described in the above embodiment and modifications may be implemented in any combination.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. An image forming apparatus comprising:
an apparatus main body;
an image forming unit configured to form an image on a sheet;
a fixing unit including a heating rotation body and a pressure rotation body that forms a nip portion between the heating rotation body and the pressure rotation body, and configured to fix the image onto the sheet; and
a cutter disposed downstream of the fixing unit in a conveying direction of the sheet and capable of cutting the sheet, wherein
the cutter is capable of cutting the sheet at a center position of the sheet in the conveying direction, and
a distance by which the sheet is conveyed from the nip portion to the cutter is larger than half of a dimension of the sheet to be cut in the conveying direction.

2. The image forming apparatus according to claim 1, wherein
the cutter is capable of cutting the sheet having at least A4 size at the center position of the sheet in the conveying direction, and
the distance by which the sheet is conveyed from the nip portion to the cutter in the conveying direction is larger than half of a dimension of the sheet having the A4 size in the conveying direction.

3. The image forming apparatus according to claim 1, wherein
the cutter is capable of cutting the sheet having at least letter size at the center position of the sheet in the conveying direction, and
the distance by which the sheet is conveyed from the nip portion to the cutter in the conveying direction is larger than half of a dimension of the sheet having legal size in the conveying direction.

4. The image forming apparatus according to claim 1, further comprising:
a conveying roller located upstream of the cutter in the conveying direction of the sheet and rotatable in an axial direction, and configured to convey the sheet toward the cutter; and
a discharge roller located downstream of the cutter in the conveying direction of the sheet and rotatable in the axial direction, and configured to discharge the sheet to the outside of the apparatus main body, wherein
dimensions of the conveying roller and the discharge roller in the axial direction are larger than half of a width of the sheet having a maximum width and capable of being conveyed by the image forming apparatus.

5. The image forming apparatus according to claim 4, wherein
the dimension of at least one of the conveying roller and the discharge roller in the axial direction is larger than the width of the sheet having the maximum width and capable of being conveyed by the image forming apparatus.

6. The image forming apparatus according to claim 1, further comprising:
a conveying roller located upstream of the cutter in the conveying direction of the sheet and configured to convey the sheet toward the cutter;
a re-conveying path configured to guide the sheet that has passed through the fixing unit toward the image forming unit again; and
a controller, wherein
the controller causes the cutter to cut one sheet into two sheets, and
the controller causes the conveying roller to rotate in a reverse direction to allow a sheet on an upstream side in the conveying direction of the cut sheets to be conveyed toward the re-conveying path.

7. The image forming apparatus according to claim 1, further comprising:
a controller, wherein
when receiving a command to cut the sheet, the controller cuts the sheet in a state in which the conveyance of the sheet stops.

8. The image forming apparatus according to claim 1, further comprising:
a first conveying path configured to guide the sheet fixed by the fixing unit to the outside of the apparatus main body;
a second conveying path different from the first conveying path and configured to guide the sheet fixed by the fixing unit to the outside of the apparatus main body; and
a controller, wherein
when the sheet is not cut by the cutter, the controller conveys the sheet to the first conveying path, and
when the sheet is cut by the cutter, the controller conveys the sheet to the second conveying path.

9. The image forming apparatus according to claim 8, further comprising:
a first discharge port through which the sheet is discharged from the first conveying path to the outside of the apparatus main body; and
a second discharge port through which the sheet is discharged from the second conveying path to the outside of the apparatus main body, wherein
the first discharge port is located closer to the fixing unit than the second discharge port.

10. The image forming apparatus according to claim 1, further comprising:
a controller, wherein
when receiving a command to cut the sheet, the controller causes the cutter to cut the sheet in a case in which a dimension in the conveying direction from an expected cutting point of the sheet to a trailing end position of the sheet is smaller than a conveying distance of the sheet from the nip portion to the cutter.

11. The image forming apparatus according to claim 10, further comprising:
an input unit capable of inputting a cutting point of the sheet, wherein
the controller cuts the sheet based on a command input to the input unit.

12. The image forming apparatus according to claim 1, further comprising:
a conveying roller located upstream of the cutter in the conveying direction of the sheet and configured to convey the sheet to the cutter; and
a controller, wherein
when the sheet is conveyed to the cutter, the controller starts to rotate the conveying roller after a leading end of the sheet in the conveying direction comes into contact with the conveying roller.

13. The image forming apparatus according to claim 1, further comprising:
a conveying roller located upstream of the cutter in the conveying direction of the sheet and configured to convey the sheet toward the cutter; and
a discharge roller located downstream of the cutter in the conveying direction of the sheet and configured to discharge the sheet to the outside of the apparatus main body, wherein
a conveying speed by the discharge roller is higher than a conveying speed by the conveying roller.
